(19) United States
(12) Patent Application Publication
(10) Pub. No.: US 2025/0153117 A1
(43) Pub. Date: May 15, 2025

(54) FILTRATION MEMBRANE AND METHOD FOR OIL AND WATER SEPARATION

(71) Applicant: KING FAHD UNIVERSITY OF PETROLEUM AND MINERALS, Dhahran (SA)

(72) Inventor: Nadeem BAIG, Dhahran (SA)

(73) Assignee: KING FAHD UNIVERSITY OF PETROLEUM AND MINERALS, Dhahran (SA)

(21) Appl. No.: 18/506,749

(22) Filed: Nov. 10, 2023

(51) Int. Cl. B01D 71/02; B01D 67/00

(52) U.S. Cl. CPC B01D 71/022; B01D 67/0039; B01D 2325/0283; B01D 2325/04

(57) ABSTRACT

A filtration membrane includes stainless-steel mesh fibers, copper, and silver. The copper and the silver coat the stainless-steel mesh fibers. The silver is the outermost layer, which covers the copper. The silver is in the form of a layer of dendritic growths in the form of branched dendritic leaves. The branched dendritic leaves are 3 to 30 μm long. A method for oil and water separation using the filtration membrane is also provided.

### STATEMENT REGARDING PRIOR DISCLOSURE BY THE INVENTORS

Aspects of the present disclosure are described in Baig et. al., “Special wettable Azadirachta indica leaves like microarchitecture mesh filtration membrane produced by galvanic replacement reaction for layered oil/water separation” published in Volume 313, Chemosphere, which is incorporated herein by reference in its entirety.

### STATEMENT OF ACKNOWLEDGEMENT

The inventors acknowledge the support provided by the Interdisciplinary Research Center for Membranes and Water Security, King Fahd University of Petroleum and Minerals, Saudi Arabia, through Project INMW2206.

### BACKGROUND

### Technical Field

The present disclosure is directed to an oil and water separation process, and particularly, to a filtration membrane comprising stainless-steel mesh fibers, copper, and silver and a method for oil and water separation using the filtration membrane.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present

Water pollution due to oil contaminants has emerged as an environmental problem due to the rapid growth of industries, urbanization, and high energy demands. The leading sources of oil pollution are periodic oil spills and oily wastewater that industries produce. Oil extraction industries contribute to oily wastewater, with each extracted barrel of oil usually producing three to ten barrels of water. The presence of oil in aquatic bodies may result in the disturbance of the oxygen level, which may lead to the death of marine organisms. Therefore, the oil and water separation process has become a task of interest due to its broad impact on the ecosystem. Various techniques, such as coagulation, adsorption, flotation, in-situ combustion, flocculation, microbial degradation, chemical dispersants, and oil skimmers, are used in oil and water separation. These methods can work in separating oil and water to an extent; however, some challenges are associated with conventional oil and water separation techniques. Challenges include, but are not limited to, the oil and water separation process being energy-intensive and inefficient, having a high operational cost, producing a source of secondary pollution, and being labor intensive.

Wettable surfaces have been used in some implementations of the oil and water separation process. Two factors, such as the chemical composition of the surface regulating the surface free energy and surface roughness at the micro/nanoscale level, [Zhou, Q., Yang, N., Zhang, Luhong, Zhang, Longfei, Li, J., Yang, X., Peng, F., Sun, Y., 2022. Structural tailored ZnO@Cu₂O heterostructure-decorated mesh with dual functionalities for oil/water separation and photodegradation. J Alloys Compd 896, 162763] have contributed to the design of wettable surfaces. The selective separation of the oil and water mixture can be realized with materials that demonstrate different wettability to oil or water [Xue, Z., Cao, Y., Liu, N., Feng, L., Jiang, L., 2014. Special wettable materials for oil/water separation. J Mater Chem A Mater 2, 2445-2460]. Superhydrophobic (water-repelling) and superoleophilic (oil-loving) surfaces selectively allow the oil to pass or adsorb and reject the water and superhydrophilic (water-loving) and superoleophobic (oil-repelling) surfaces selectively allow the water permeation and reject the oil [Wang, Y., Yan, J., Wang, J., Zhang, X., Wei, L., Du, Y., Yu, B., Ye, S., 2020. Superhydrophobic metal organic framework doped polycarbonate porous monolith for efficient selective removal oil from water. Chemosphere 260, 127583; and Chen, J., Xiao, X., Xu, Y., Liu, J., Lv, X., 2021. Fabrication of hydrophilic and underwater superoleophobic SiO₂/silk fibroin-coated mesh for oil/water separation. J Environ Chem Eng 9, 105085]. The water contact angle defines the wettability of the surfaces. The surfaces are defined as hydrophobic when the water contact angle is in a range of 900 to 1500 and the materials are considered superhydrophobic if the water contact angle exceeds 150° [Parvate, S., Dixit, P., Chattopadhyay, S., 2020. Superhydrophobic Surfaces: Insights from Theory and Experiment. Journal of Physical Chemistry B 124, 1323-1360]. Copper and stainless steel-based meshes have received attention in separating oil and water mixtures. Copper mesh is usually used for oil-water separation and various nanostructures are introduced on its surface to increase the surface roughness and hydrophobicity [Cao, H., Fu, J., Liu, Y., Chen, S., 2018. Facile design of superhydrophobic and superoleophilic copper mesh assisted by candle soot for oil-water separation. Colloids Surf A Physicochem Eng Asp 537, 294-302; and Song, Y., Liu, Y., Zhan, B., Kaya, C., Stegmaier, T., Han, Z., Ren, L., 2017. Fabrication of Bioinspired Structured Superhydrophobic and Superoleophilic Copper Mesh for Efficient Oil-water Separation. J Bionic Eng 14, 497-505]. Copper mesh is expensive and less accessible than other metals, making copper mesh an unfriendly option for scale-up. Stainless steel meshes are an apt choice due to their low cost, good mechanical strength, and ability sustain in harsh conditions [Saleh, T. A., Baig, N., Othman, H. A., al Harith, A. M., 2021. Removal of alkanes by novel grassy cabbage microbuds prepared by an electrochemical method. Chemical Engineering Journal 407, 126216]. Several superhydrophobic stainless steel meshes have been used to separate the oil and water mixtures in literature. The hydrophobicity of the meshes is usually improved using various organic linkers; however, the organic linkers may contribute secondary contaminants, such as fluorocarbons, which may be considered a high environmental risk [Jiang, L., Tang, Z., Park-Lee, K. J., Hess, D. W., Breedveld, V., 2017. Fabrication of non-fluorinated hydrophilic-oleophobic stainless steel mesh for oil-water separation. Sep Purif Technol 184, 394-403]. There is a need to develop superhydrophobic and superoleophilic meshes or materials for the oil and water separation process.

Accordingly, an object of the present disclosure is to develop an environment-friendly oil and water separation process without the use organic linkers. Another objective of the present disclosure is to develop a filtration membrane that has improved oil and water separation efficiency and high flux to overcome limitations of the art.

### SUMMARY

In an exemplary embodiment, a filtration membrane is described. The filtration membrane includes stainless-steel mesh fibers, copper, and silver. The copper and the silver coat the stainless-steel mesh fibers. The silver is an outermost layer covering the copper. The silver is in the form of a layer of dendritic growths in the form of branched dendritic leaves. The branched dendritic leaves are 3 to 30 micrometer (μm) long.

In some embodiments, the silver is at least 50 percent by weight zerovalent silver based on a total weight of silver.

In some embodiments, the filtration membrane is made by a process including electrochemically depositing copper from a copper-containing solution on the stainless-steel mesh fibers to form a stainless-steel copper mesh material. The process further includes periodically submerging the stainless-steel copper mesh material into a silver-containing solution to form a stainless-steel copper silver mesh product and drying the stainless-steel copper silver mesh product.

In some embodiments, electrochemically depositing the copper from the copper-containing solution occurs with a two-electrode electrolysis system at a potential difference of 4.0 volts (V) for 30 minutes.

In some embodiments, submerging the stainless-steel copper mesh material into the silver-containing solution galvanically displaces the copper with the silver and forms the dendritic growths.

In some embodiments, submerging the stainless-steel copper mesh material into the silver-containing solution occurs for 10 seconds at intervals.

In some embodiments, drying the stainless-steel copper silver mesh product occurs at a temperature of 120° C.

In another exemplary embodiment, a method for oil and water separation is described. The method includes contacting the filtration membrane with an oil-water mixture. An oil from the oil-water mixture permeates through the filtration membrane and water from the oil-water mixture is blocked from permeating through the filtration membrane.

In some embodiments, the oil from the oil-water mixture is dichloromethane.

In some embodiments, the filtration membrane has a flux of 8950 to 9000 L m⁻²h⁻¹.

In some embodiments, the filtration membrane has a separation efficiency of oil and water of 96.5 to 99.5% by weight, based on a weight of the oil in the oil-water mixture.

In some embodiments, the branched dendritic leaves have the shape of Azadirachta indica leaves.

In some embodiments, the filtration membrane has a thickness of 100 to 150 μm.

In some embodiments, the filtration membrane has a water contact angle of 155 to 165°.

In some embodiments, the filtration membrane includes iron, copper, silver, carbon, oxygen, and chromium.

In some embodiments, the method further includes contacting the filtration membrane 10 to 20 times with the oil-water mixture.

In some embodiments, the filtration membrane has a separation efficiency of oil and water of 96.5 to 99.5% by weight, based on the weight of the oil in the oil-water mixture after contacting the filtration membrane 10 to 20 times with the oil-water mixture.

In some embodiments, the oil from the oil-water mixture permeates through the filtration membrane via gravity.

In some embodiments, the filtration membrane has pores with a diameter of 1 to 50 μm.

In some embodiments, no organic linkers are present in the filtration membrane.

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure (including alternatives and/or variations thereof) and many of the attendant advantages thereof will be readily obtained as the same becomes better understood by reference to the following detailed description when considered in connection with the accompanying drawings, wherein:

FIG. 1 is a flowchart depicting a method of making a membrane, according to certain embodiments;

FIG. 2A shows a scanning electron microscope (SEM) image of a pristine mesh (p-Mesh), at different magnifications, according to certain embodiments;

FIG. 2B shows an SEM image of electrochemically deposited copper-coated stainless-steel mesh (EC-Cu-Mesh) material, at different magnifications, according to certain embodiments;

FIG. 2C shows an SEM image of Ag-decorated electrochemically deposited copper-coated stainless-steel mesh (SH-AIL-Ag-EC-Cu-Mesh) at different magnifications, according to certain embodiments;

FIG. 3 shows an energy dispersive X-ray (EDX) spectrum of the SH-AIL-Ag-EC-Cu-Mesh, according to certain embodiments;

FIG. 4A shows an elemental mapping (EDS) layered image of the SH-AIL-Ag-EC-Cu-Mesh, according to certain embodiments;

FIG. 4B shows an EDS image of the SH-AIL-Ag-EC-Cu-Mesh with iron (Fe), according to certain embodiments;

FIG. 4C shows an EDS image of the SH-AIL-Ag-EC-Cu-Mesh with copper (Cu), according to certain embodiments;

FIG. 4D shows an EDS image of the SH-AIL-Ag-EC-Cu-Mesh with silver (Ag), according to certain embodiments;

FIG. 4E shows an EDS image of the SH-AIL-Ag-EC-Cu-Mesh with carbon (C), according to certain embodiments;

FIG. 4F shows an ED S image of the SH-AIL-Ag-EC-Cu-Mesh with oxygen (O), according to certain embodiments;

FIG. 4G shows an EDS image of the SH-AIL-Ag-EC-Cu-Mesh with chromium (Cr), according to certain embodiments;

FIG. 5A shows an X-ray photoelectron spectroscopy (XPS) spectrum in the energy range of a C is signal of the SH-AIL-Ag-EC-Cu-Mesh, according to certain embodiments;

FIG. 5B shows an XPS spectrum in the energy range of an Ag 3d signal of the SH-AIL-Ag-EC-Cu-Mesh, according to certain embodiments;

FIG. 5C shows an XPS spectrum in the energy range of a Cu 2p signal of the SH-AIL-Ag-EC-Cu-Mesh, according to certain embodiments;

FIG. 5D shows an XPS spectrum in the energy range of a 0 is signal of the SH-AIL-Ag-EC-Cu-Mesh, according to certain embodiments;

FIG. 6A shows surface wettability analysis of the p-Mesh, according to certain embodiments;

FIG. 6B shows surface wettability analysis of the SH-AIL-Ag-EC-Cu-Mesh, according to certain embodiments;

FIG. 7A shows water contact angle (WCA) on the p-Mesh, according to certain embodiments;

FIG. 7B shows WCA on the SH-AIL-Ag-EC-Cu-Mesh, according to certain embodiments;

FIG. 7C is a histogram showing the WCA values with the p-Mesh and the SH-AIL-Ag-EC-Cu-Mesh, according to certain embodiments;

FIG. 8 is a schematic illustration of oil/water separation using the SH-AIL-Ag-EC-Cu-Mesh, according to certain embodiments;

FIG. 9 is a pictorial representation of the separation of an oil/water mixture using a separation assembly containing the SH-AIL-Ag-EC-Cu-Mesh, according to certain embodiments; and

FIG. 10 shows separation efficiency and reusability of SH-AIL-Ag-EC-Cu-Mesh for the separation of oil/water mixtures, according to certain embodiments.

### DETAILED DESCRIPTION

In the following description, it is understood that other embodiments may be utilized, and structural and operational changes may be made without departure from the scope of the present embodiments disclosed herein.

Reference will now be made to specific embodiments or features, examples of which are illustrated in the accompanying drawings. In the drawings, whenever possible, corresponding or similar reference numerals will be used to designate identical or corresponding parts throughout the several views. Moreover, references to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

As used herein, the term “membrane” refers to a porous structure that is capable of separating components of a homogeneous or heterogeneous fluid. A membrane may be a layer of varying thickness of semi-permeable material that may be used for solute separation as a transmembrane pressure is applied across the membrane. A degree of selectivity may be based on membrane composition, charge, and porosity. Membranes may have symmetric or asymmetric pores, wherein a membrane with asymmetric pores have variable pore diameters. Membranes may be used for microfiltration, ultrafiltration, nanofiltration, and reverse osmosis process. In particular, “pores” in the context of the present disclosure indicate voids allowing fluid communication between different sides of the structure. Pores may have a varying pore size, pore size distribution, and pore morphology, such as pore shape and surface roughness. The pores may be made up of a network of interconnected channels. More particular in use when a homogeneous or heterogeneous fluid is passed through the membrane, some components of the fluid can pass through the pores of the membrane into a “permeate stream,” while some components of the fluid can be retained by the membrane and can thus accumulate in a “retentate,” and/or some components of the fluid can be rejected by the membrane into a “rejection stream.” Membranes can be of various thicknesses, with homogeneous or heterogeneous structures. Membranes can be in the form of flat sheets or bundles of hollow fibers. Membranes can also be in various configurations including, but not limited to, spiral wound, tubular, hollow fiber, and other configurations identifiable to a skilled person upon a reading of the present disclosure. Membranes can also be classified according to their pore diameter. Membranes can be neutral or charged, and particle transport can be active or passive. The latter can be facilitated by pressure, concentration, and chemical or electrical gradients of the membrane process.

As used herein, the term “filtration” refers to the mechanical or physical operation or process which can be used for separating components of homogeneous or heterogeneous solutions. Filtration may use a filter medium to separate components of homogeneous and heterogenous solutions. The filter medium may be a physical separator, such as a membrane, a chemical separator or gradient, an electrical separator or gradient, and any separator or gradient known in the art for separating solutions. Filtration may be used to separate solids from liquids, solids from gases, and/or liquids from other liquids. Filtration may be gravity-driven, pressure-driven, and/or vacuum-driven.

Aspects of the present disclosure are directed to an Ag-decorated electrochemically deposited copper-coated stainless-steel mesh (SH-AIL-Ag-EC-Cu-Mesh)-based filtration membrane for efficient separation of oil/water mixtures. A process for making the membrane is also described. The SH-AIL-Ag-EC-Cu-Mesh was thoroughly characterized by scanning electron microscopy (SEM), energy dispersive X-ray (EDX) spectroscopy, elemental mapping analysis, X-ray photoelectron spectroscopy (XPS), surface wettability, water contact angles (WCAs), and was further evaluated for its potential to separate an oil-water mixture. The membrane of the present disclosure demonstrated selectivity for oil in oil/water mixtures with a separation efficiency of 99.1% and a high flux of 8963 L m⁻²h⁻¹. The SH-AIL-Ag-EC-Cu-Mesh has shown reusability properties with, after 15 cycles of separation, an oil/water separation efficiency of at least 96% was observed.

Aspects of the present disclosure are directed to a filtration membrane. The filtration membrane is also referred to as a “membrane.” The filtration membrane includes a hydrophobic mesh material. The hydrophobic mesh is a silver- and copper-coated stainless-steel mesh. The filtration membrane comprises stainless-steel mesh fibers coated and/or deposited with copper and silver.

In a specific embodiment, the filtration membrane includes one or more layers of copper deposited on the stainless-steel mesh. The deposition of the one or more layers of copper may be via electrochemical techniques, or any other methods known in the art, to form the stainless-steel copper mesh material. In an embodiment, the oxidation state of copper is +1, +2, or may exist by itself (oxidation state is zero or zerovalent) or a combination thereof. In a preferred embodiment, the oxidation state of copper is predominantly +1 or 0, with less than 20%, preferably less than 15%, more preferably less than 10%, and yet more preferably less than 5% of the copper existing in the +2 oxidation state.

The filtration membrane further includes one or more layers of silver covering the stainless-steel copper mesh material. The silver is an outermost layer covering the copper. The silver is not agglomerated. The silver can exist in various oxidation states, +1, +2, or may exist by itself (oxidation state is zero or zerovalent). In an embodiment, at least 50 percent by weight of the silver is zerovalent based on the total weight of silver. In some embodiments, at least 55 percent, at least 60 percent, at least 65 percent, at least 70 percent, at least 75 percent, at least 80 percent, at least 85 percent, preferably at least 90 percent, more preferably at least 95 percent, and yet more preferably about 100 percent by weight of the silver is zerovalent based on a total weight of silver.

The silver is in the form of a layer of dendritic growths in the form of branched dendritic leaves. The branched dendritic leaves are three dimensional. The branched dendritic leaves are 3 to 30 μm, preferably 5 to 20 μm, preferably 10 to 15 μm long. In an embodiment, a single leaf of the branched dendritic leaves may have a thickness of 2 to 100 nm, preferably 5 to 50 nm, preferably 10 to 30 nm. In an embodiment, the branched dendritic leaves may form in any direction to cover a surface of the stainless-steel copper mesh material. In an embodiment, the branched dendritic leaves cover at least 80%, preferably at least 85%, preferably at least 90%, more preferably at least 95%, and yet more preferably about 100% of a surface area of the stainless-steel copper mesh material. In some embodiments, there may be multiple layers of dendritic growths in the form of branched dendritic leaves. In some embodiments, the branched dendritic leaves may grow in one or more bunches. In some embodiments, a first bunch of the branched dendritic leaves may overlap with a second bunch of the branched dendritic leaves. In an embodiment, the branched dendritic leaves may comprise 2 to 100 leaves, preferably 5 to 80 leaves, more preferably 10 to 60 leaves, and yet more preferably 15 to 40 leaves on a branch. In an embodiment, the branched dendritic leaves comprise 5 to 50 branches, preferably 10 to 40 branches, preferably 20 to 30 branches on a stem. In some embodiments, the dendritic growths may comprise 1 to 50 stems, preferably 5 to 40 stems, preferably 10 to 30 stems, preferably 20 to 25 stems. In some embodiments, the branched dendritic leaves may be on branches, stems, or a combination thereof. In an embodiment, the branched dendritic leaves are in the shape of Azadirachta indica leaves. In some embodiments, the branched dendritic leaves have the shape of any tree, plant, flower, and/or bush leaves known in the art.

Energy-dispersive X-ray spectroscopy (EDX) analysis reveals that the membrane of the present disclosure includes other elements such as iron, carbon, oxygen, and chromium, in addition to copper and silver, which form the constituents of the stainless steel.

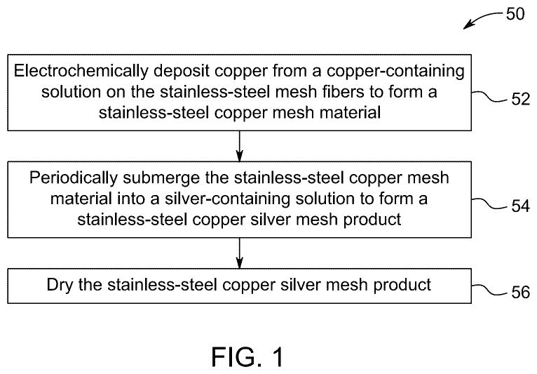

A method for making the membrane is described. Referring to FIG. 1, a flowchart diagram of a method of making the membrane is illustrated. The order in which the method 50 is described is not intended to be construed as a limitation, and any number of the described method steps may be combined in any order to implement the method 50. Additionally, individual steps may be removed or skipped from the method 50 without departing from the spirit and scope of the present disclosure.

At step 52, the method 50 includes electrochemically depositing copper from a copper-containing solution on the stainless-steel mesh fibers to form a stainless-steel copper mesh material. The stainless-steel mesh is initially cleaned via sonication in a solution of ethanol and water before electrochemically depositing copper. In one or more embodiments, the sonication solution is ethanol, water, and/or equal parts ethanol and water. In an embodiment, the water may be deionized water, distilled water, double distilled water, water purified by reverse osmosis, tap water, the like, and a combination thereof. In a preferred embodiment, the stainless-steel mesh is cleaned via sonication in deionized water first, and then cleaned via sonication in ethanol following the sonication in deionized water. In one or more embodiments, the stainless-steel mesh is sonicated in water and then ethanol for approximately 10-60 minutes, preferably 20-50 minutes, preferably 25-40 minutes, more preferably 30-40 minutes, and yet more preferably about 30 minutes. In some embodiments, the cleaned mesh is dried before electrochemically depositing copper. The stainless-steel mesh can be of various dimensions and thicknesses depending on the desired size of the final membrane.

After the stainless-steel mesh is cleaned, the stainless-steel mesh is electroplated or electrochemically deposited with copper from a copper-containing solution. The copper-containing solution includes a copper salt. In a preferred embodiment, the copper salt is copper sulfate, more specifically, copper(II) sulfate pentahydrate. Optionally, other salts of copper, such as CuCl₂, Cu(NO₃)₂, CuCO₃, hydrates thereof, the like, may be used in place of or in combination with copper(II) sulfate pentahydrate. The concentration of the copper salt in the copper-containing solution is in the range of 0.05-4 M, preferably 0.1-1 M, and more preferably about 0.1-0.5 M.

During the electrochemical deposition, a potential is applied via an electrolysis unit to the solution, which causes the copper in the copper-containing solution to attach to, or deposit on, the surface of the stainless-steel mesh, resulting in the stainless-steel copper mesh material. In an embodiment, the potential applied via the electrolysis unit is 1.0-4.0 V, preferably about 4.0 V. In some embodiments, the applied potential may be varied. In a preferred embodiment, the applied potential is held at a constant potential of 4.0 V. In an embodiment, the potential is applied to the solution for approximately 10-60 minutes, preferably 20-50 minutes, more preferably 30-40 minutes, and yet more preferably 30 minutes, to achieve a layer of copper coating on the stainless-steel mesh. The copper coating may be uniform or non-uniform. In a preferred embodiment, the copper coating is uniform. In an embodiment, after the electrochemical deposition, the surface of the mesh is washed with deionized water while the potential is still being applied to remove non-reduced Cu²⁺ ions from the surface of the stainless-steel copper mesh material.

Prior to electrodeposition, in some embodiments, a strong oxidizing agent is added to the copper-containing solution. Suitable examples of the oxidizing agent include, but are not limited to, oxygen, ozone, hydrogen peroxide, inorganic peroxides, Fenton's reagent, fluorine, chlorine, other halogens, nitric acid, nitrate compounds, sulfuric acid, MnO₄⁻ (permanganate), CrO₄²⁻ (chromate), OsO₄ (osmium tetroxide), ClO₄⁻ (perchlorate), the like, and a combination thereof. In a preferred embodiment, the oxidizing agent is sulfuric acid. The concentration is in a range of 1-4 M, more preferably 2-3 M, and yet more preferably about 3 M. The electrodeposition of copper on the stainless-steel mesh fibers is carried out at a temperature range of 20-37° C., preferably 22-35° C., and yet more preferably 25-32° C. to form the stainless-steel copper mesh material.

At step 54, the method 50 includes periodically submerging the stainless-steel copper mesh material into a silver-containing solution to form a stainless-steel copper silver mesh product. In an embodiment, the silver-containing solution includes a silver salt. Suitable examples of silver salt include, but are not limited to, silver bromide (AgBr), silver chloride (AgCl), silver iodide (AgI), silver nitrate, silver nitrite, the like, and/or combinations thereof. In a preferred embodiment, the silver salt is silver nitrate. The concentration of the silver nitrate is in a range of 0.01 to 1 M, preferably 0.02 to 0.5 M, preferably 0.03 to 0.2 M, preferably 0.04 to 0.1 M, more preferably 0.05 to 0.06 M, and yet more preferably about 0.05 M. The copper in the stainless-steel copper mesh material, upon being submerged the silver-containing solution, is galvanically displaced with silver to form dendritic growths. This is due to a standard reduction potential of the half reaction of silver(I) to silver(0) having a greater value (0.80 V) than the standard reduction potential of the half reaction of copper(II) to copper(0) (0.34 V). Silver(I) from the silver-containing solution is able to replace copper(0) and be reduced to silver(0) spontaneously while copper(0) is oxidized to copper(II) due to the difference of the standard reduction potentials. Copper(0) is being oxidized to copper(II) at the same time silver(I) is being reduced to silver(0) with no applied potential. In an embodiment, the stainless-steel copper mesh material is submerged into the silver-containing solution, at periodic intervals until a top layer of the copper is displaced from a top layer the stainless-steel copper mesh material. In an embodiment, the copper is completely displaced from a top layer of the stainless-steel copper mesh material. In an embodiment, the stainless-steel copper mesh material is submerged into the silver-containing solution for 5-15 seconds, preferably 6-14 seconds, preferably 7-13 seconds, preferably 8-12 seconds, more preferably 9-11 seconds, and yet more preferably about 10 seconds. In an embodiment, the periodic intervals may be from 5 seconds to 2 hours, preferably 30 seconds to 1 hour, preferably 60 seconds to 30 minutes, more preferably 2 to 20 minutes, and yet more preferably 5 to 10 minutes.

At step 56, the method 50 includes drying the stainless-steel copper silver mesh product. The stainless-steel copper silver mesh product can be dried at a temperature of 60-150° C., preferably 70-140° C., preferably 80-130° C., preferably 90-120° C., more preferably 100-120° C., and yet more preferably about 120° C. The drying may be carried out in an oven. The drying may be dried for 2-72 hours, more preferably 12-60 hours, and yet more preferably 24-48 hours.

The thickness of the membrane prepared by the method 50 of the present disclosure is in a range of 100-150 μm, preferably 105-145 μm, preferably 110-140 μm, preferably 115-135 μm, preferably 120-130 μm, more preferably 120-125 μm, and yet more preferably about 120 μm. The membrane comprises pores with a diameter of 1 to 50 μm, preferably 5 to 25 μm, and more preferably about 10 to 20 μm.

In one or more embodiments, the membrane of the present disclosure is superhydrophobic, and may have a water contact angle of approximately 155 to 165°. Moreover, the membrane of the present disclosure has a reduced production cost, a controlled morphology, and a good separation efficiency for the separation of non-polar components from water (for example, in excess of 99% based on mass).

The membrane has a flux of 8950 to 9000 L m⁻² h⁻¹, preferably 8960 to 8990 L m⁻² h⁻¹, and more preferably about 8963 L m⁻² h⁻¹. The membrane has a separation efficiency of oil and water of 96.5 to 99.5%, preferably 97-99.4%, preferably 98-99.3%, more preferably 99-99.3%, and yet more preferably 99.1% by weight, based on the weight of the oil in the oil-water mixture. The membrane of the present disclosure demonstrates high stability, in that the membrane can be used multiple times without compromising on the separation efficiency. In an embodiment, the membrane can be contacted with the oil-water mixture about 10-20 times, preferably 11-19 times, preferably 12-18 times, preferably 13-17 times, preferably 14-16 times, preferably 15 times without compromising the separation efficiency.

An advantage of the membrane prepared by the present disclosure is the absence of any organic linkers, that are generally used in conventionally prepared membranes, thereby overcoming the challenges associated with environmental toxicity.

The membrane prepared by the method of the present disclosure may be used in separating an oil and water mixture. The oil and water mixture may include one or more oils selected from toluene, hexane, cyclohexane, dichloromethane, plant oil, isooctane, lubricating oil, motor oil, crude oil, diesel oil, gasoline, a combination thereof, and the like. In a preferred embodiment, the oil from the oil-water mixture is dichloromethane. During the separation process, the membrane allows for selective permeation of oil from the oil-water mixture. During the separation process, water from the oil-water mixture is blocked from permeating through the filtration membrane. The oil from the oil-water mixture permeates through the filtration membrane via gravity. In some embodiments, the oil from the oil-water mixture may permeate through the filtration membrane via vacuum filtration, applied pressure filtration, a combination thereof, and any other filtration techniques known in the art.

### EXAMPLES

The following examples describe and demonstrate exemplary embodiments of the filtration membrane and a method for oil and water separation using the filtration membrane as described herein. The examples are provided solely for the purpose of illustration and are not to be construed as limitations of the present disclosure, as many variations thereof are possible without departing from the spirit and scope of the present disclosure.

### Materials

CuSO₄·5H₂O and AgNO₃ were purchased from Sigma Aldrich. Dichloromethane (DCM) was obtained from MilliporeSigma. The deionized water was used to prepare the various solutions to modify the mesh. The deionized water with 18.2 MΩ resistance was collected from a lab-based PURELAB flex unit.

### Instrumentation

A PHYWE (Germany) electrolyzer was used for the electrodeposition of the copper. It is a two-electrode system, where the anode is a platinum wire and the cathode includes the stainless-steel mesh. The chemical analysis of the copper-coated stainless-steel mesh (SH-AIL-Ag-EC-Cu-Mesh) was performed using the ESCALAB 250Xi XPS (Thermo Scientific, USA). The morphologies of the pristine and various modified meshes were analyzed using the JSM-6610LV scanning electron microscope (SEM) (JEOL, Japan). The surface wettability of the meshes was studied by placing the 5 μL drop of water on the meshes. The water contact angle was performed using the Drop Shape Analyzer (Kruss, Germany).

Procedure of fabrication of the SH-AIL-Ag-EC-Cu-Mesh membrane Before copper electroplating on the stainless-steel mesh fibers, the mesh was cleaned with water and ethanol. The mesh was placed in deionized water and sonicated for 30 minutes, a similar procedure was repeated with ethanol, and then the clean mesh was dried. A stainless-steel mesh membrane piece was attached to the electrolyzer containing approximately 14 grams of CuSO₄·5H₂O in 500 mL of water. The electrolyzer includes a two-electrode system. About 40 mL of 3 M H₂SO₄ was added to the CuSO₄·5H₂O solution. A potential difference of 4.0 V was applied for 30 minutes to electrodeposit the copper from the solution. After 30 minutes, the electrochemically deposited copper-coated stainless-steel mesh (EC-Cu-Mesh) was removed from the solution while keeping the potential on. It was thoroughly washed with deionized water before being detached from the electrolyzer. After disconnecting from the electrolyzer, the EC-Cu-Mesh was dipped for 10 seconds into a 0.05 M AgNO₃ solution and taken out. This process was repeated until no copper was seen on the surface of the mesh. The periodical dipping was done to avoid the formation of big, fragile lumps on the surface of the mesh. After modification with the AgNO₃, the SH-AIL-Ag-EC-Cu-Mesh membrane was kept overnight for drying and then heated overnight at 120° C. The thickness of the stainless-steel mesh was about 120 μm. The fabricated SH-AIL-Ag-EC-Cu-Mesh was stored at room temperature for further characterization and experimental evaluation.

### Oil/Water Mixture Separation

The SH-AIL-Ag-EC-Cu-Mesh membrane was cut into a suitable size to fit into the separation assembly. The oil-water mixture was prepared by taking 100 mL of dichloromethane and 100 mL of water to make a layered oil-water mixture. The oil-water mixture was slowly poured into the separation assembly. The reusability of the SH-AIL-Ag-EC-Cu-Mesh membrane was also analyzed by taking the equivalent amount of oil and water and repeating the slow pouring in each evaluation step.

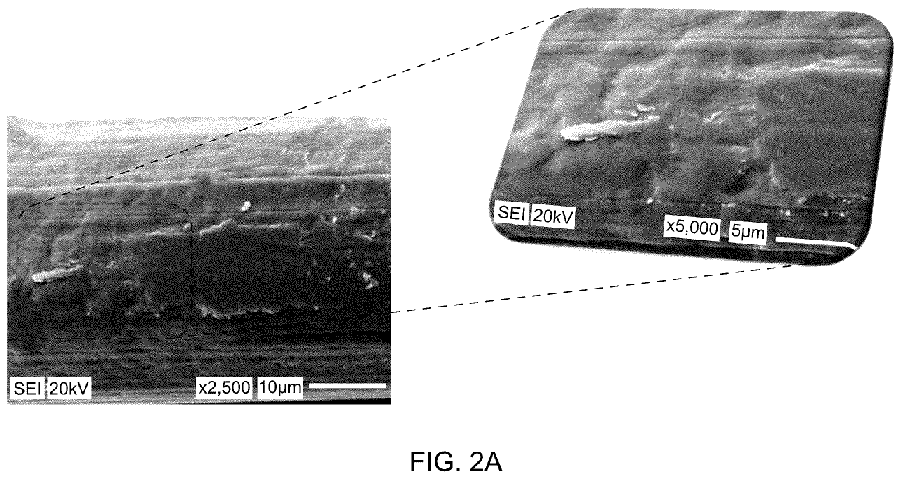

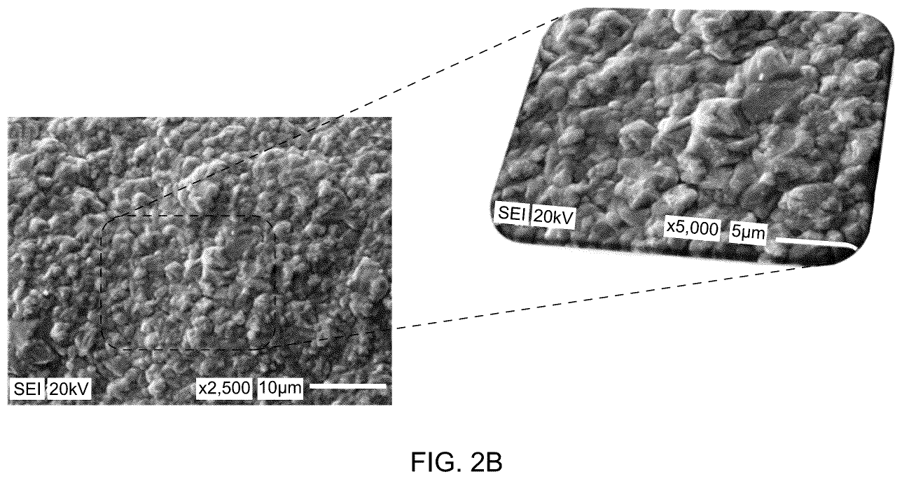

In designing and fabricating wettable membranes, surface morphology plays a role. It is seen that on flat surfaces, the maximum contact angle usually achieved is 120°, irrespective of the chemical composition of the surface [Spori, D. M., Drobek, T., Zurcher, S., Ochsner, M., Sprecher, C., Mühlebach, A., Spencer, N. D., 2008. Beyond the lotus effect: Roughness influences on wetting over a wide surface-energy range. Langmuir 24, 5411-5417, incorporated herein by reference in its entirety]. Surface engineering is needed to turn the surfaces into superhydrophobic surfaces; therefore, surface morphologies contribute to the design of wettable surfaces [Goharshenas Moghadam, S., Parsimehr, H., Ehsani, A., 2021. Multifunctional superhydrophobic surfaces. Adv Colloid Interface Sci 290, 102397, incorporated herein by reference in its entirety]. The surface analysis of the pristine mesh (p-Mesh), the electrochemically deposited copper-coated stainless-steel mesh (EC-Cu-Mesh) material, and the SH-AIL-Ag-EC-Cu-Mesh (FIGS. 2A-2C) has shown a change in the surface after each step of surface modifications. The surface of the p-Mesh appeared somewhat smoother with some irregularities (FIG. 2A). The electrodeposition of the copper from the CuSO₄ increased the surface roughness of the EC-Cu-Mesh; however, this roughness is not very prominent. Still, changes on the surface of the EC-Cu-Mesh can be observed after the electrodeposition of copper (FIG. 2B). The morphology of the EC-Cu-Mesh was changed after interaction with the AgNO₃ solution. Dense silver leaves were observed over the surface of the fibers of the EC-Cu-Mesh. These grown silver leaves look like Azadirachta indica leaves, which are extended on the surface of the mesh so that the large voids of the p-Mesh turn into smaller holes in SH-AIL-Ag-EC-Cu-Mesh (FIG. 2C). The smaller voids of the SH-AIL-Ag-EC-Cu-Mesh create air pockets that impact the hydrophobicity of the filtration membrane. The silver tree-like structure was observed after interacting AgNO₃ with water, and zinc. The repetitive and hierarchical structures are complex and contain functions for oil and water separation. Through the SEM images, it seen that the surface morphology has changed from a smooth, planar surface to a surface rough with silver dendrites.

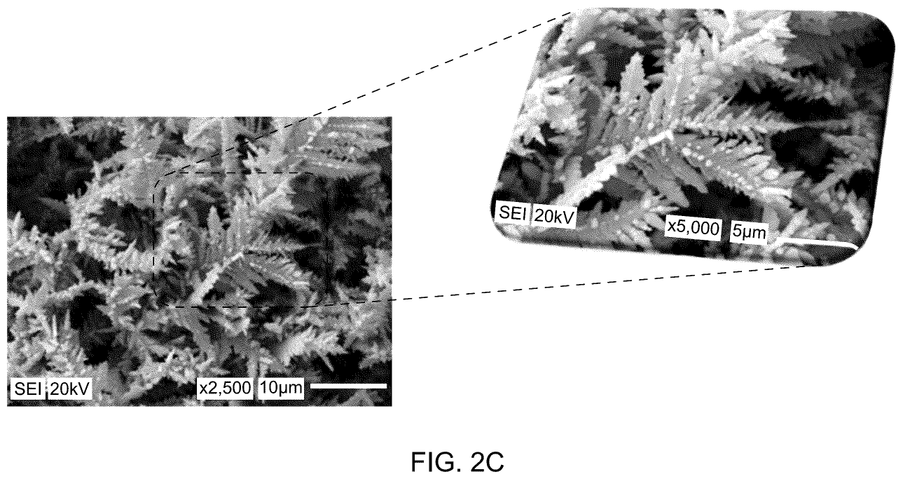

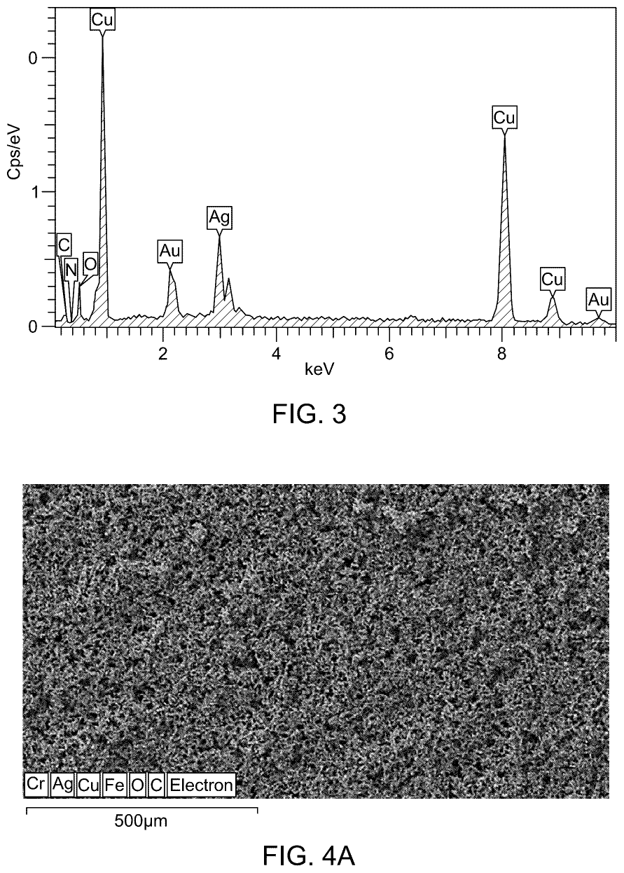

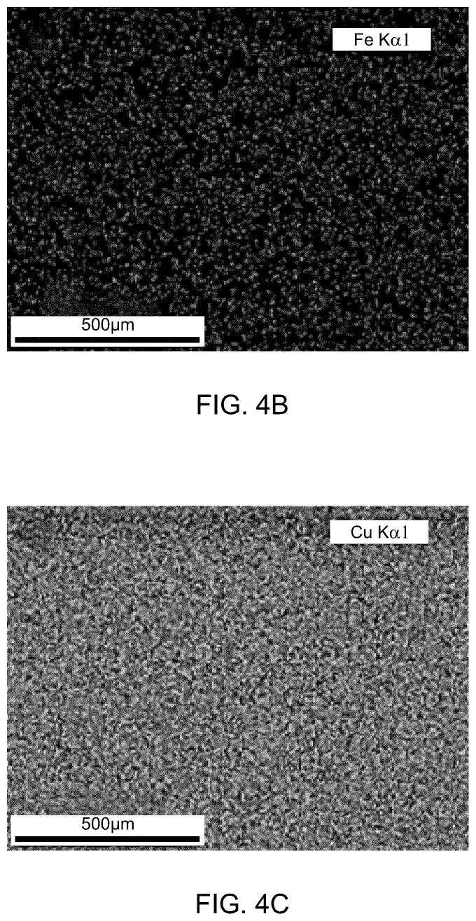

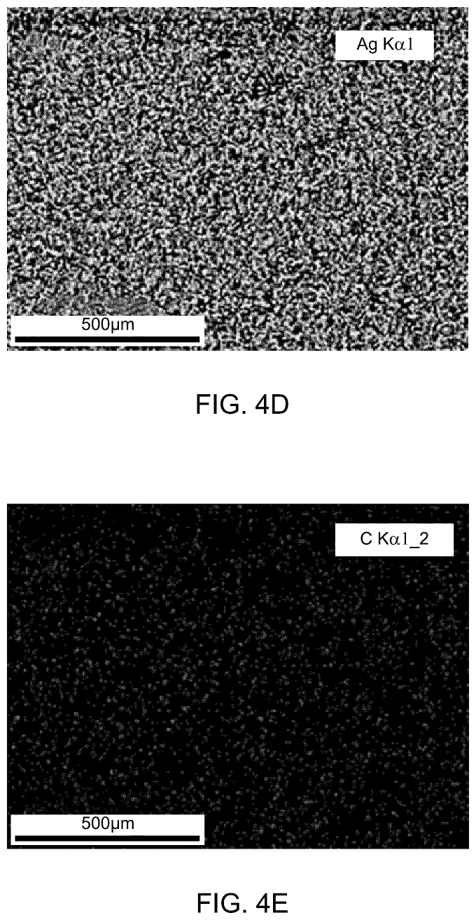

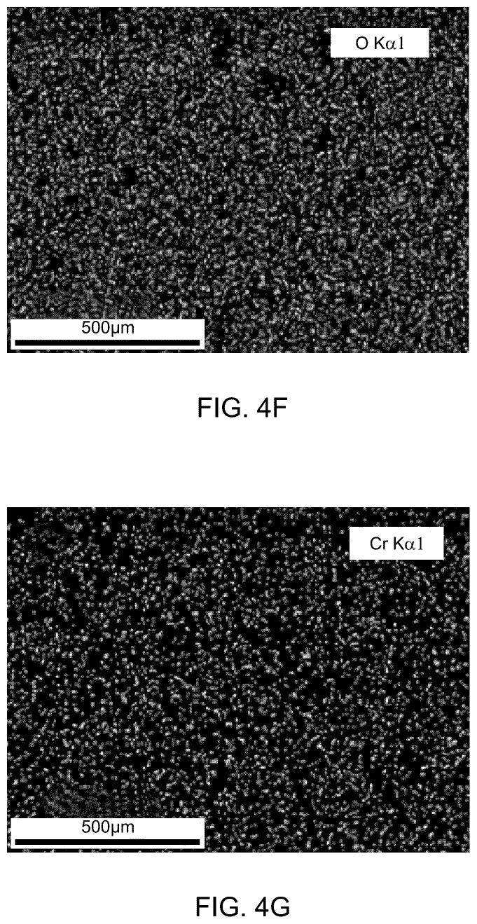

The energy dispersive X-ray (EDX) analysis and elemental mapping were carried out to see the elemental composition and spread of the elements on the surface of the SH-AIL-Ag-EC-Cu-Mesh. In the EDX spectra (FIG. 3), the sharp peak of Cu and Ag was observed with the weak peak of carbon and oxygen. The Au peak in the EDX spectrum appeared due to the gold coating before SEM and EDX analysis. The elemental mapping (FIGS. 4A-4G) has been done for an area to obtain a detailed overview of the spread of the various elements on the SH-AIL-Ag-EC-Cu-Mesh surface. In the elemental mapping, different elements were observed, including Cr (FIG. 4G), Cu (FIG. 4C), Ag (FIG. 4D), Fe (FIG. 4B), O (FIG. 4F), C (FIG. 4E), and a layered image of the elements (FIG. 4A). The Cr, Fe, and C are the constituents of stainless-steel mesh. The Cu surfaced due to the electrodeposition of Cu²⁺ on the surface of the mesh, and Ag was seen due to the galvanic displacement reaction between the AgNO₃ and the copper. In the elemental mapping, the uniform distribution of copper and silver was observed. The oxygen also appeared in the mapping. The X-ray photoelectron spectroscopy (XPS) showed that this oxygen is associated with copper, and the Ag is present in the zerovalent form. The EDX spectrum and the elemental mapping analysis support that the electrodeposition and the galvanic displacement reaction occurred. The SEM images have shown that after the reduction of Ag, branched dendritic structures appear on the surface of the mesh.

The SEM, EDX, and elemental mapping have shown the presence of Ag on the surface of the mesh, and SEM images have shown the branched dendritic morphology in which silver leaves have been grown. The chemistry behind the formation of Ag leaves is based on a galvanic replacement reaction. The galvanic replacement reaction has been used to form several different kinds of metallic morphologies and nanocomposites, which have been obtained with the interactions of metals with various redox potentials [Guo, Z., Lu, J., Wang, D., Xie, W., Chi, Y., Xu, J., Takuya, N., Zhang, J., Xu, W., Gao, F., Wu, H., Zhao, L., 2021. Galvanic replacement reaction for in situ fabrication of litchi-shaped heterogeneous liquid metal-Au nano-composite for radio-photothermal cancer therapy. Bioact Mater 6, 602-612; and Bansal, V., Jani, H., du Plessis, J., Coloe, P. J., Bhargava, S. K., 2008. Galvanic Replacement Reaction on Metal Films: A One-Step Approach to Create Nanoporous Surfaces for Catalysis. Advanced Materials 20, 717-723, both of which are incorporated herein by reference in their entireties]. Galvanic (or spontaneous) replacement of Au ions with Ag ions is possible as the Au ions reduction potential is greater than the Ag ions reduction potential. A metal can spontaneously reduce the Ag ions with a standard reduction potential that is lower than the standard reduction potential of Ag⁺. The Ag⁺/Ag (Ag⁺ (aq)+e⁻ [symbol] Ag(s)) half reaction standard reduction potential is +0.79 V [Pradhan, N., Pal, A., Pal, T., 2002. Silver nanoparticle catalyzed reduction of aromatic nitro compounds. Colloids Surf A Physicochem Eng Asp 196, 247-257, incorporated herein by reference in its entirety] and the Cu²⁺/Cu (Cu²⁺ (aq)+2e⁻→Cu(s)) redox potential is +0.34. Therefore, the galvanic replacement immediately starts as the EC-Cu-Mesh encountered the AgNO₃ aqueous solution. Silver dendritic growth is observed when the polycrystalline aggregates into a single crystal [Fang, J., You, H., Kong, P., Yi, Y., Song, X., Ding, B., 2007. Dendritic silver nanostructure growth and evolution in replacement reaction. Cryst Growth Des 7, 864-867]. The oriented attachment mechanism can be used to explain the silver nanostructures' morphological and structural evolution. Thus, during the replacement reaction, the Ag might align their atomic lattices and grow into unique leave-like structures, which was observed on the surface of the SH-AIL-Ag-EC-Cu-Mesh.

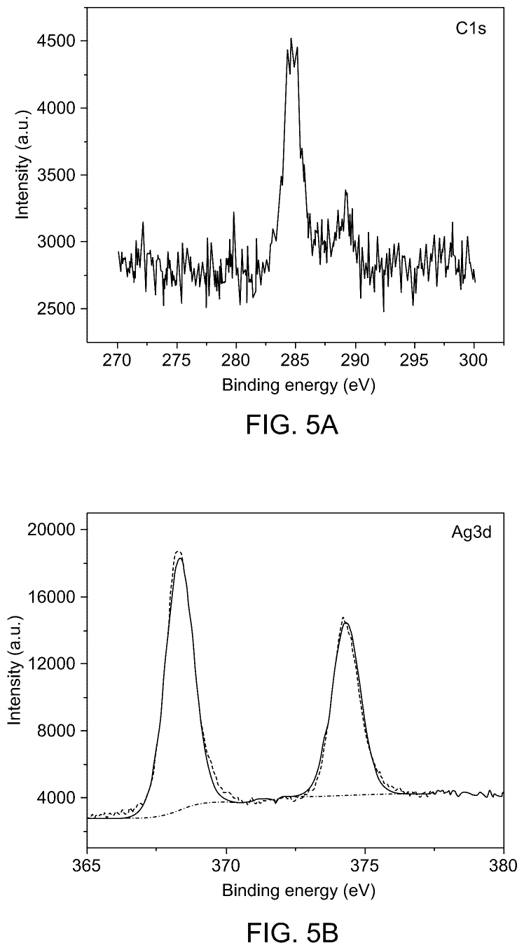

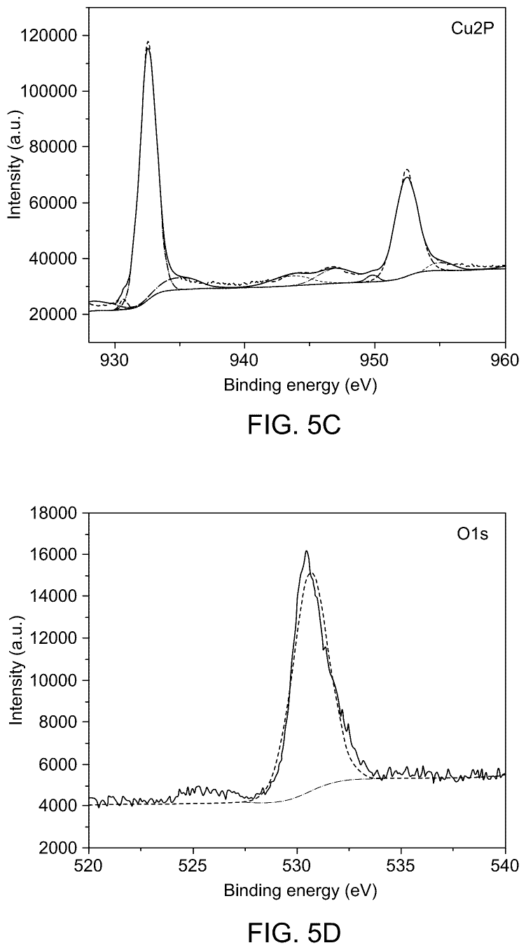

XPS spectra have provided information regarding the chemical composition and environment of the SH-AIL-Ag-EC-Cu-Mesh. XPS scanning extracted the chemical information from a depth of 5-10 nm. The high-resolution spectra of the main elements, which include silver, copper, and oxygen, can be seen in FIG. 5A-5D. An adventitious carbon peak was observed at 284.6 eV. The high-resolution spectra of the Ag 3d provided information regarding Ag's oxidation state on the SH-AIL-Ag-EC-Cu-Mesh's surface. The two typical peaks of the Ag 3d spectrum were observed at the binding energies of 368.3 and 374.3 eV related to the Ag 3d_{5/2} and Ag 3d_{3/2}, respectively. These are the core energy levels that appeared due to spin-orbit coupling. These binding energies of the Ag microarchitecture are in good agreement with bulk and Ag metal nanoparticles [Parashar, P. K., Komarala, V. K., 2017. Engineered optical properties of silver-aluminum alloy nanoparticles embedded in SiON matrix for maximizing light confinement in plasmonic silicon solar cells. Scientific Reports 2017 7:1 7, 1-9, incorporated herein by reference in its entirety]. Similar values were seen for zerovalent Ag [Oliveira, C., Chaves, C. R., Bargiela, P., da Rocha, M. da G. C., da Silva, A. F., Chubaci, J. F. D., Bostrom, M., Persson, C., Malta, M., 2021. Surface studies of the chemical environment in gold nanorods supported by X-ray photoelectron spectroscopy (XPS) and ab initio calculations. Journal of Materials Research and Technology 15, 768-776, incorporated herein by reference in its entirety]. The binding energies of the Ag 3d are evident that the Ag(I) reduced on the surface of the mesh, which contributes to the hydrophobicity of the SH-AIL-Ag-EC-Cu-Mesh. The prominent peaks in the high-resolution spectra of Cu 2p are observed for Cu 2p_{3/2} and Cu 2p_{1/2} at the binding energies of 932.6 eV and 952.4 eV, respectively. These binding energies are related to the Cu(I). It is tough to distinguish between the Cu(I) and the Cu(0) due to their close binding energies [Lee, S. Y., Mettlach, N., Nguyen, N., Sun, Y. M., White, J. M., 2003. Copper oxide reduction through vacuum annealing. Appl Surf Sci 206, 102-109, incorporated herein by reference in its entirety]. A small quantity of copper is also present in Cu(II), as the binding energy was observed at 935 eV. This binding energy is related to the divalent copper [Li, Q., Li, K., Sun, C., Li, Y., 2007. An investigation of Cu²⁺ and Fe²⁺ ions as active materials for electrochemical redox supercapacitors. Journal of Electroanalytical Chemistry 611, 43-50, incorporated herein by reference in its entirety]. Thus, in a galvanic replacement reaction, most of the produced Cu(II) transfers to the solution and is not present in a prominent amount on the surface of the mesh. The XPS shows that the small portion of the copper on the surface of the SH-AIL-Ag-EC-Cu-Mesh is divalent, and the rest of the copper might be present as a monovalent or zerovalent species. The O is peak signature at 530.6 eV is also consistent with the oxidation state of Cu₂O [Li, J., Mei, Z., Liu, L., Liang, H., Azarov, A., Kuznetsov, A., Liu, Y., Ji, A., Meng, Q., Du, X., 2014. Probing Defects in Nitrogen-Doped Cu₂O. Scientific Reports 2014 4:1 4, 1-6, incorporated herein by reference in its entirety]. The XPS study indicated that the electrochemically deposited Cu successfully reduced the Ag(I). The copper moves to the immersed solution in the form of Cu(II) to replace the Ag(I) ions; therefore, only a slight XPS peak of the Cu(II) was observed. The weak intensities might appear due to the presence of copper in the form of Cu₂O or CuO, and the rest of the copper might be present in the zerovalent form along with the reduced Ag, which grown on the surface of the SH-AIL-Ag-EC-Cu-Mesh.

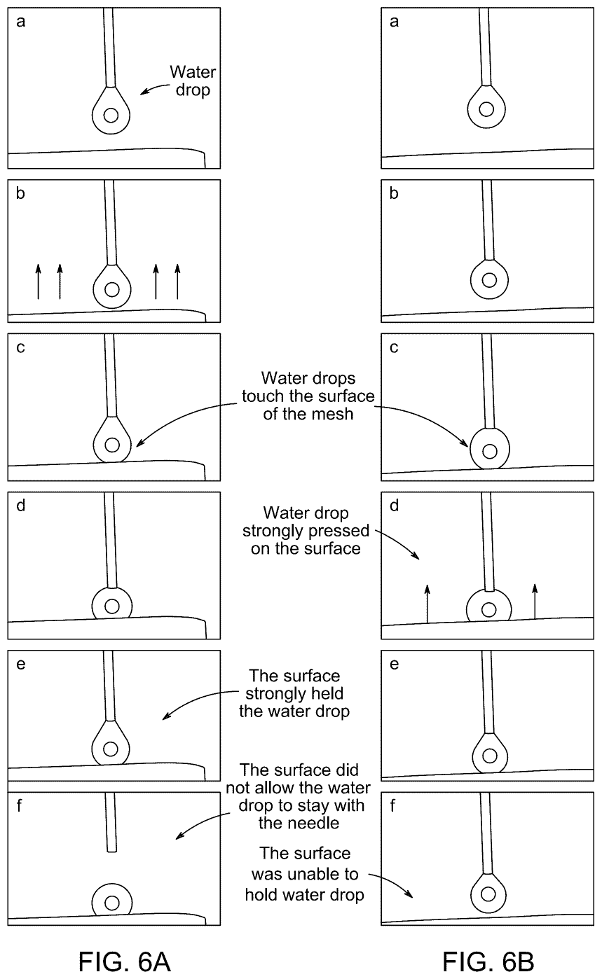

Wettability is an intrinsic characteristic of a material. Surface chemistry and morphology are factors in determining a material's wettability [Chen, C., Weng, D., Mahmood, A., Chen, S., Wang, J., 2019. Separation Mechanism and Construction of Surfaces with Special Wettability for Oil/Water Separation. ACS Appl Mater Interfaces 11, 11006-11027, incorporated herein by reference in its entirety]. The surface wettability behavior of a material determines whether the material will allow the passage of the oil or water [Saleh, T. A., Baig, N., 2019. Efficient chemical etching procedure for generating superhydrophobic surfaces for separation of oil from water. Prog Org Coat 133, 27-32, incorporated herein by reference in its entirety] or may be incapable of selectivity, and both phases will pass through the material. Wettability achieves efficient separation of the oil/water and contributes to the separation process [Baig, N., Alghunaimi, F. I., Dossary, H. S., Saleh, T. A., 2019. Superhydrophobic and superoleophilic carbon nanofiber grafted polyurethane for oil-water separation. Process Safety and Environmental Protection 123, 327-334, incorporated herein by reference in its entirety]. Determining the surface behavior of the p-Mesh and the SH-AIL-Ag-EC-Cu-Mesh towards water helps in determining the mesh membranes' effectiveness for oil and water separation. The microneedle attached to the contact angle goniometer can produce a micro-size water droplet to analyze the surface wettability of the pristine and modified mesh membranes. The surface of the p-Mesh and the SH-AIL-Ag-EC-Cu-Mesh was moved up towards the microneedle holding the water droplet. The surfaces of the meshes were moving upward until they touched the water droplet, then moved further up to press to the water droplet and provide the maximum opportunity for the surfaces to hold the water droplet. It can be seen in FIGS. 6A-6B, that the water droplet is pressed on the surface of the p-Mesh (FIG. 6A) and the SH-AIL-Ag-EC-Cu-Mesh (FIG. 6B). It is pressed more firmly on the surface of the SH-AIL-Ag-EC-Cu-Mesh. As the surface of the meshes is lowered to its initial position, both surfaces behaved differently. The water droplet has shown an affinity for the p-Mesh, and as the surface of the mesh moves down, the water droplet starts to detach from the microneedle. The surface of the p-Mesh pulled the water drops towards its surface. The water drop was separated from the microneedle, showing that the p-Mesh has an affinity for the water.

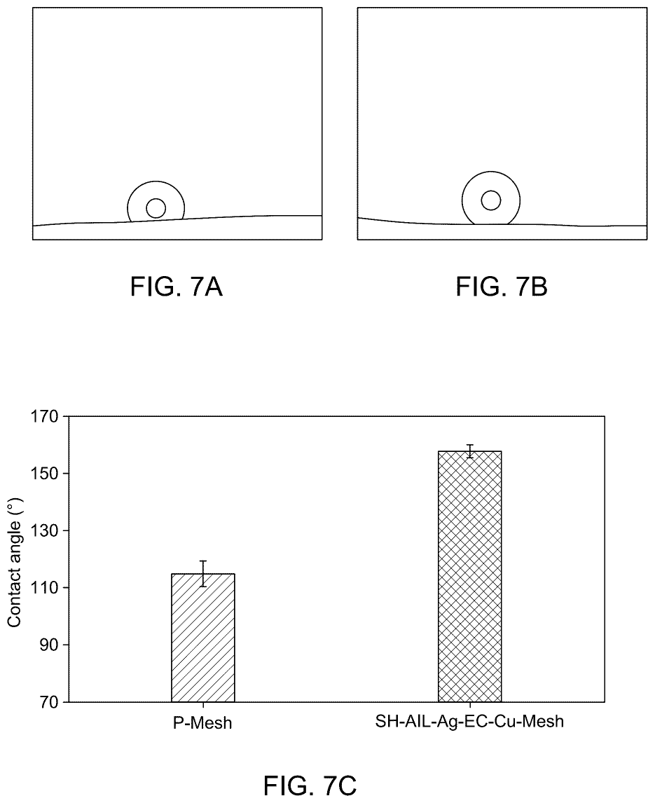

The SH-AIL-Ag-EC-Cu-Mesh proved impotent to hold the water drop while moving downward, and the water drop stayed with the SH-AIL-Ag-EC-Cu-Mesh. This attitude of the SH-AIL-Ag-EC-Cu-Mesh has shown that its surface contained hydrophobic properties to reject the water. In another experiment, methylene blue-colored water was dropped on the microstructure mesh's surface and the SH-AIL-Ag-EC-Cu-Mesh's surface immediately wiped the water off. The surface of the SH-AIL-Ag-EC-Cu-Mesh remained clear from any stain of methylene blue-color water. During a rolling of the water droplet on the SH-AIL-Ag-EC-Cu-Mesh's surface, the surface remained dry and no wettability was observed. The water contact angle on the surface of the mesh provides information regarding the surfaces' hydrophobicity and hydrophilicity [Saleh, T. A., Baig, N., Alghunaimi, F. I., Aljuryyed, N. W., 2020. A flexible biomimetic superhydrophobic and superoleophilic 3D macroporous polymer-based robust network for the efficient separation of oil-contaminated water. RSC Adv 10, 5088-5097, incorporated herein by reference in its entirety]. Surfaces are superhydrophobic if the water contact angle is greater than 150°. The water contact angle on the p-Mesh was observed at about 115°±4°; however, on the surface of the SH-AIL-Ag-EC-Cu-Mesh, the contact angle was observed at more than 150°, which identified the surface of the modified mesh as superhydrophobic (FIGS. 7A-7C).

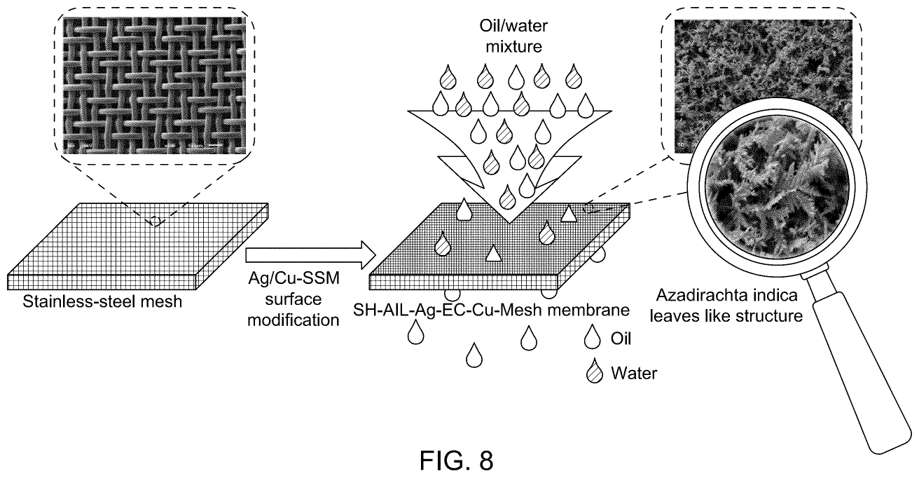

The surface wettability analysis has shown that the rationally designed SH-AIL-Ag-EC-Cu-Mesh repels water, making it suitable for selectively separating the oil from water (FIG. 8). The practicality of the SH-AIL-Ag-EC-Cu-Mesh was evaluated by exposing it to an oil-water mixture. A mixture of water and dichloromethane was prepared by adding an equal quantity of oil and water to simulate a heavy oil-water mixture. The oils made a lower layer that appeared orange, and the water made an upper layer that appeared blue. Different dyes are used to color the oil and water to make them easily distinguishable. The contamination of one in the other can be recognized by eye. The oil-water mixture was slowly poured into the separation assembly, where the SH-AIL-Ag-EC-Cu-Mesh was mounted. During the separation process, SH-AIL-Ag-EC-Cu-Mesh has shown selectivity towards oil, allowing the oil to permeate the SH-AIL-Ag-EC-Cu-Mesh and not allowing water to permeate. As discussed, due to the density difference, the water made an upper layer, and the oil made a lower layer. During pouring, the water first encountered the SH-AIL-Ag-EC-Cu-Mesh and would like to penetrate through it, but the mesh surface superhydrophobicity prevented it from penetrating. As the heavy oil reached the surface of the SH-AIL-Ag-EC-Cu-Mesh, the surface behaved differently. During pouring, the oil immediately moved toward the mesh's surface from the water phase, and the mesh's surface selectively allowed oil to permeate through it. The separation process continued until the oil moved from the oil-water mixture into the oil container.

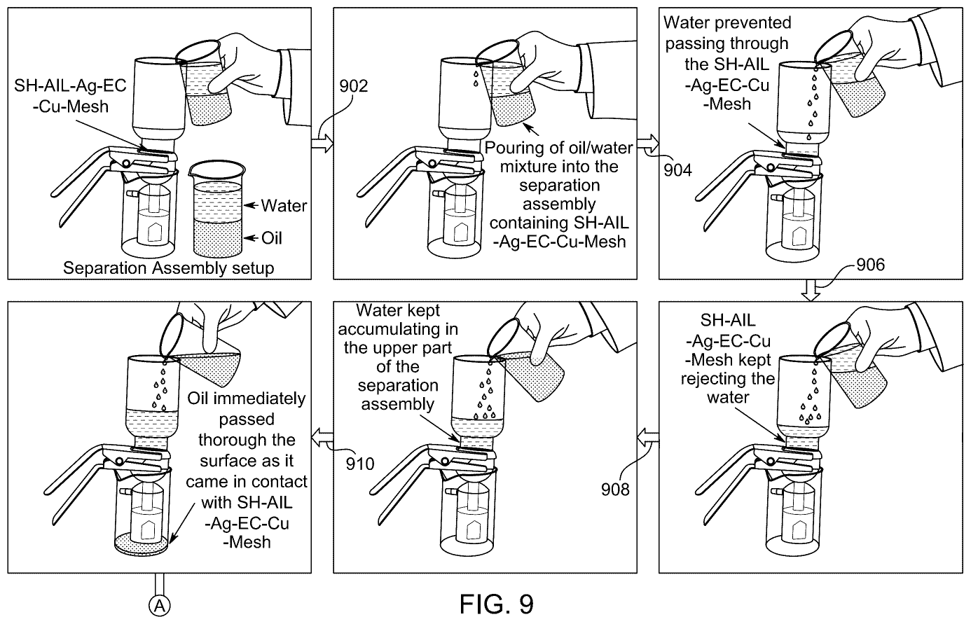

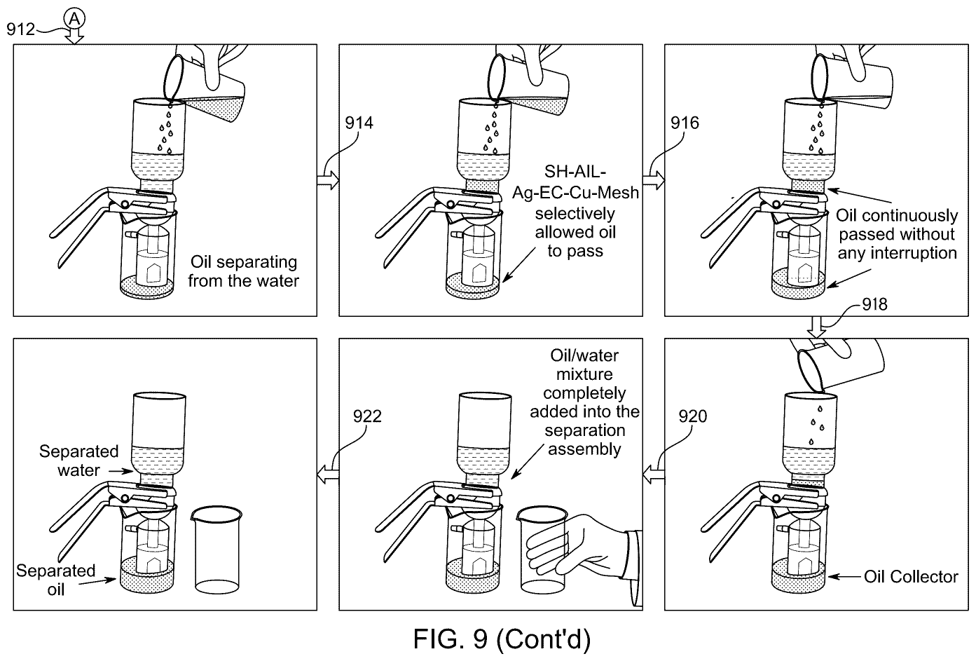

FIG. 9 is a schematic illustration depicting a separation assembly for the separation of the oil-water mixture. The SH-AIL-Ag-EC-Cu-Mesh was used for the separation of the oil-water mixture. At step 902, the method includes pouring the oil-water mixture into the separation assembly containing the SH-AIL-Ag-EC-Cu-Mesh. When the water in the oil-water mixture comes in contact with the SH-AIL-Ag-EC-Cu-Mesh, water is prevented from passing through the SH-AIL-Ag-EC-Cu-Mesh due to the hydrophobic nature of the mesh (904 and 906). While the water kept accumulating in the upper part of the separation assembly (908), the oil in the oil-water mixture immediately passed through or permeated through the SH-AIL-Ag-EC-Cu-Mesh (910, 912, 914, and 916). The separated oil is collected in an oil collector (918). Over time, the oil-water mixture added into the separation assembly is wholly separated (920) to yield separated water and oil (922). The separation behavior revealed the superhydrophobicity and superoleophilicity of the fabricated filtration membrane.

The flux and the separation efficiency are factors in determining the performance of the materials for oil and water separation. A heavy oil-water mixture has been prepared using dichloromethane and water [Gao, X, Zhou, J, Du, R, Xie, Z, Deng, S, Liu, R, Liu, Z, Zhang, J, 2016. Robust Superhydrophobic Foam: A Graphdiyne-Based Hierarchical Architecture for Oil/Water Separation. Advanced Materials 28, 168-173, incorporated herein by reference in its entirety]. High flux is a desired characteristics for the rapid separation of the oil-water mixtures. The flux of the SH-AIL-Ag-EC-Cu-Mesh was found by the following equation [Baig, N., Saleh, T. A., 2021. A facile development of superhydrophobic and superoleophilic micro-textured functionalized mesh membrane for fast and efficient separation of oil from water. J Environ Chem Eng 9, 105825, incorporated herein by reference in its entirety]:

$$F = V / ( A \times t )$$

where F is the flux, V is the permeated volume (m³), A is the surface area of the membrane (m²), and t is the time of the liquid permeation (h). The SH-AIL-Ag-EC-Cu-Mesh has shown a high flux while separating the layered oil-water mixtures. The flux was observed at about 8963 L m⁻² h⁻¹. The high flux has shown the strong affinity of the surface towards the oil; as the oil encountered the surface, it rapidly spread and penetrated through it.

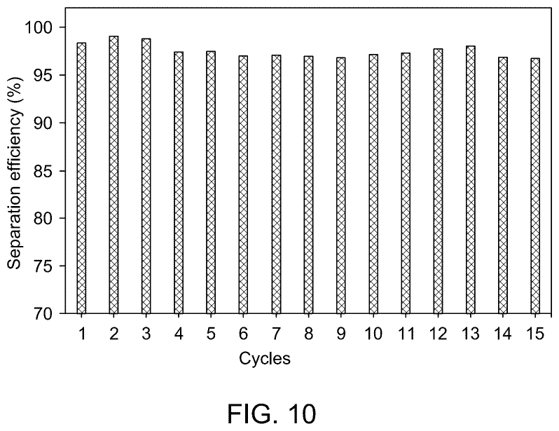

The separation efficiency was found using the following equation [Wang, Q., Li, Q., Yasir Akram, M., Ali, S., Nie, J., Zhu, X., 2018. Decomposable Polyvinyl Alcohol-Based Super-Hydrophobic Three-Dimensional Porous Material for Effective Water/Oil Separation. Langmuir 34, 15700-15707, incorporated herein by reference in its entirety]:

$$χ = ( \frac{M s}{M f} ) \times 100$$

where χ represents the percentage of separation efficiency, Ms indicates the weight of the separated oil from the oil-water mixture, and Mf is the weight of the oil in the feed. The designed SH-AIL-Ag-EC-Cu-Mesh has shown good separation efficiency, where the maximum separation efficiency was observed at about 99.1% and the lowest was at about 96.8%. The reusability of the materials is a factor in the practicality of the materials for the oil/water separation. The SH-AIL-Ag-EC-Cu-Mesh was continuously evaluated for the 15 cycles (FIG. 10). The average separation efficiency was observed at about 97.6% with the RSD±1. The performance of the SH-AIL-Ag-EC-Cu-Mesh with the reported literature can be found in Table 1.

TABLE 1
Comparison of the SH-AIL-Ag-EC-Cu-Mesh performance with
the previously reported superhydrophobic meshes.

| Superhydrophobic | Surface | Mode of | Water contact | Separation |
|---|---|---|---|---|
| meshes | morphology | separation | angle | efficiency |
| Cu(OH)₂@ZIF-8 | Cu(OH)₂@ZIF-8 | Under | 153 ± 0.6° | 97.2% |
| Nanowire Membranes | core/shell | gravity | | |
| [Ref. A] | nanowire grown | | | |
| | on copper mesh | | | |
| Superhydrophobic and | Nanostructured | Under | 153° | >90% |
| superoleophilic | organic film | gravity | | |
| steel@CS@PPy@SA | | | | |
| mesh [Ref. B] | | | | |
| SiO₂-coated super- | Multi-level rough | Under | 153.3° | 96% |
| hydrophobic/super- | microstructures | gravity | | |
| oleophilic mesh [Ref. C] | | | | |
| Super-hydrophobic FAS | microscale surface | Under | 124.4 ± 1.5° to 167.9 ± 2.1° | 96.8% |
| modified electroless Ni-P | roughness | gravity | | |
| coating meshes [Ref. D] | | | | |
| Super-hydrophobic copper | Nanoneedle | Under | 153° | 87.5% to 97.5% |
| mesh [Ref. E] | | gravity | | |
| Copper-mesh [Ref. F] | Roughness | Under | >150° | 95% |
| | produced by | gravity | | |
| | candle soot | | | |
| Sepiolite-based super- | Rough micro-nano | Under | 153.6° | 97.3% |
| hydrophobic stainless- | synapse | gravity | | |
| steel mesh [Ref. G] | | | | |
| Polydimethylsiloxane - | Cu(OH)₂ | Under | 160.2° ± 2.6° | 98.89% |
| copper meshes [Ref. H] | nanoneedles and | gravity | | |
| | CuO nanoplates | | | |
| POSS hybrid acrylic | hierarchical | Under | 153° | 99% |
| polymer coated stainless | structures | gravity | | |
| steel mesh [Ref. I] | | | | |
| Superhydrophobic | Mountain-like | Under | 154° | >95% |
| ferromagnetic nickel | rough structure | gravity | | |
| particles coated stainless- | | | | |
| steel mesh [Ref. J] | | | | |
| SH-AIL-Ag-EC-Cu-Mesh | Azadirachta indica | Under | 158° | 99.1% |
| [Ref. K] | leaves like | gravity | | |
| | microarchitecture | | | |

Ref A corresponds to Li, Q., Deng, W., Li, C., Sun, Q., Huang, F., Zhao, Y., Li, 5., 2018. High-Flux Oil/Water Separation with Interfacial Capillary Effect in Switchable Superwetting Cu(OH)2@ZIF-8 Nanowire Membranes. ACS Appl Mater Interfaces 10, 40265-40273, incorporated herein by reference in its entirety; Ref. B corresponds to Khosravi, M., Azizian, S., 2017. Preparation of superhydrophobic and superoleophilic nanostructured layer on steel mesh for oil-water separation. Sep Purif Technol 172, 366-373, incorporated herein by reference in its entirety; Ref. C corresponds to Zhao, L., Du, Z., Tai, X., Ma, Y., 2021b. One-step facile fabrication of hydrophobic SiO₂ coated super-hydrophobic/super-oleophilic mesh via an improved Stober method to efficient oil/water separation. Colloids Surf A Physicochem Eng Asp 623, 126404, incorporated herein by reference in its entirety; Ref. D corresponds to Cai, Y., Li, S., Cheng, Z., Xu, G., Quan, X., Zhou, Y., 2018. Facile fabrication of super-hydrophobic FAS modified electroless Ni—P coating meshes for rapid water-oil separation. Colloids Surf A Physicochem Eng Asp 540, 224-232, incorporated herein by reference in its entirety; Ref. E corresponds to Lu, Y., Li, Z., Hailu, G., Xu, D., Wu, H., Kang, W., 2019. Study on the oil/water separation performance of a super-hydrophobic copper mesh under downhole conditions. Journal of Industrial and Engineering Chemistry 72, 310-318, incorporated herein by reference in its entirety; Ref F corresponds to Cao, H., Fu, J., Liu, Y., Chen, S., 2018. Facile design of superhydrophobic and superoleophilic copper mesh assisted by candle soot for oil water separation. Colloids Surf A Physicochem Eng Asp 537, 294-302, incorporated herein by reference in its entirety; Ref G corresponds to Huang, Z., Liu, Y., He, W., Tu, W., Chen, M., Zhu, M., Liu, R., 2022. Fabrication of sepiolite-based super-hydrophobic stainless steel mesh for enhanced stability and high efficiency oil-water separation. Colloids Surf A Physicochem Eng Asp 635, 127938, incorporated herein by reference in its entirety; Ref. H corresponds to Pang, B., Liu, H., Liu, P., Zhang, H., Avramidis, G., Chen, L., Deng, X., Viol, W., Zhang, K., 2019. Robust, Easy-Cleaning Superhydrophobic/Superoleophilic Copper Meshes for Oil/Water Separation under Harsh Conditions. Adv Mater Interfaces 6, 1900158, incorporated herein by reference in its entirety; Ref. I corresponds to Guo, D., Hou, K., Xu, S., Lin, Y., Li, L., Wen, X., Pi, P., 2018. Superhydrophobic-superoleophilic stainless steel meshes by spray-coating of a POSS hybrid acrylic polymer for oil-water separation. J Mater Sci 53, 6403-6413, incorporated herein by reference in its entirety; Ref. J corresponds to Xu, J., Chen, Y., Shen, L., Zhao, J., Lou, G., Huang, D., Yang, Y., 2022. Fabrication of superhydrophobic stainless-steel mesh for oil-water separation by jet electrodeposition. Colloids Surf A Physicochem Eng Asp 649, 129434, incorporated herein by reference in its entirety; and Ref. K corresponds to work of present disclosure.

According to the present disclosure, a superhydrophobic/superoleophilic SH-AIL-Ag-EC-Cu-Mesh was designed and utilized for oil and water separation. The silver leaves are decorated on the surface of the mesh through a two-step process. In the first step, on the stainless steel mesh's surface, the copper is electrochemically deposited from the copper(II) solution. In the second step, a displacement reaction took place by placing the EC-Cu-Mesh in the Ag(I) solution where the displacement took place, and the Ag leaves rapidly grew on the EC-Cu-Mesh, which resulted in the superhydrophobic SH-AIL-Ag-EC-Cu-Mesh. The XPS analysis has shown that most of the Ag is present in the zerovalent form on the surface of the mesh. The SEM images revealed the uniform distribution of the Ag Azadirachta indica-like leaves covering the open pores of the mesh. The water contact angle on the surface of the SH-AIL-Ag-EC-Cu-Mesh was greater than 150°. The designed mesh has shown good separation efficiency, as high as 99.1%, during the separation of the oil-water mixtures.

Moreover, the separation efficiency has remained high during several reusability cycles, indicating the mesh membrane's stability. Furthermore, the surface superhydrophobicity of the SH-AIL-Ag-EC-Cu-Mesh can be restored quickly after heating at 120° C. A high oil and water separation flux was realized at 8963 L m⁻² h⁻¹. The galvanic replacement reaction of AgNO₃ and the electrochemically deposited Cu is a unique strategy for designing superhydrophobic/superoleophilic materials without using any organic linker for oil and water separation.

Numerous modifications and variations of the present disclosure are possible in light of the above teachings. It is therefore to be understood that within the scope of the appended claims, the present disclosure may be practiced otherwise than as specifically described herein.

1: A filtration membrane, comprising:
stainless-steel mesh fibers;
copper; and
silver,
wherein the copper and the silver coat the stainless-steel mesh fibers,
wherein the silver is an outermost layer covering the copper,
wherein the silver is in the form of a layer of dendritic growths in the form of branched dendritic leaves,
wherein the branched dendritic leaves are 3 to 30 μm long.

2: The filtration membrane of claim 1, wherein the silver is at least 50 percent by weight zerovalent silver based on a total weight of silver.

3: The filtration membrane of claim 1, wherein the filtration membrane is made by a process comprising:
electrochemically depositing copper from a copper-containing solution on the stainless-steel mesh fibers to form a stainless-steel copper mesh material;
periodically submerging the stainless-steel copper mesh material into a silver-containing solution to form a stainless-steel copper silver mesh product; and
drying the stainless-steel copper silver mesh product.

4: The filtration membrane of claim 3, wherein electrochemically depositing the copper from the copper-containing solution occurs with a two-electrode electrolysis system at a potential difference of 4.0 V for 30 minutes.

5: The filtration membrane of claim 3, wherein submerging the stainless-steel copper mesh material into the silver-containing solution galvanically displaces the copper with the silver and forms the dendritic growths.

6: The filtration membrane of claim 3, wherein submerging the stainless-steel copper mesh material into the silver-containing solution occurs for 10 seconds at intervals.

7: The filtration membrane of claim 3, wherein drying the stainless-steel copper silver mesh product occurs at a temperature of 120° C.

8: A method for oil and water separation, comprising:
contacting the filtration membrane of claim 1 with an oil-water mixture,
wherein an oil from the oil-water mixture permeates through the filtration membrane and water from the oil-water mixture is blocked from permeating through the filtration membrane.

9: The method of claim 8, wherein the oil from the oil-water mixture is dichloromethane.

10: The method of claim 8, wherein the filtration membrane has a flux of 8950 to 9000 L m⁻² h⁻¹.

11: The method of claim 8, wherein the filtration membrane has a separation efficiency of oil and water of 96.5 to 99.5% by weight, based on a weight of the oil in the oil-water mixture.

12: The method of claim 8, wherein the branched dendritic leaves have the shape of Azadirachta indica leaves.

13: The method of claim 8, wherein the filtration membrane has a thickness of 100 to 150 μm.

14: The method of claim 8, wherein the filtration membrane has a water contact angle of 1550 to 165°.

15: The method of claim 8, wherein the filtration membrane comprises iron, copper, silver, carbon, oxygen, and chromium.

16: The method of claim 8, further comprising:
contacting the filtration membrane 10 to 20 times with the oil-water mixture.

17: The method of claim 16, wherein the filtration membrane has a separation efficiency of oil and water of 96.5 to 99.5% by weight, based on the weight of the oil in the oil-water mixture.

18: The method of claim 8, wherein the oil from the oil-water mixture permeates through the filtration membrane via gravity.

19: The method of claim 8, wherein the filtration membrane has pores with a diameter of 1 to 50 μm.

20: The method of claim 8, wherein no organic linkers are present in the filtration membrane.
